(19) United States
(12) Patent Application Publication
(10) Pub. No.: US 2008/0313251 A1
(43) Pub. Date: Dec. 18, 2008

(54) SYSTEM AND METHOD FOR GRAPH COARSENING

(76) Inventors: Li Ma, Beijing (CN); Yue Pan, Beijing (CN); Chen Wang, Beijing (CN); Zhemin Zhu, Beijing (CN)

Correspondence Address: IBM CORPORATION, T.J. WATSON RESEARCH CENTER, P.O. BOX 218, YORKTOWN HEIGHTS, NY, 10598, US

(21) Appl. No.: 12/136,191

(22) Filed: Jun. 10, 2008

(30) Foreign Application Priority Data
Jun. 15, 2007 (CN) 200710110101.4

(51) Int. Cl. G06F 17/10

(52) U.S. Cl. 708/290

(57) ABSTRACT

A method for coarsening a graph, the graph including a plurality of vertices, the method incorporating:
selecting a vertex from the plurality of vertices;
calculating a merge modularity gain between the selected vertex and its adjacent vertices, wherein the adjacent vertices are a function of the position of the selected vertex in the graph;
calculating mathematically a similarity between the selected vertex and its adjacent vertices;
determining mathematically, based on the calculated merge modularity gain and similarity, whether the selected vertex can be merged with one of its adjacent vertices; and
performing the merge when merge is determined possible and updating the list of adjacent vertices.

A system and a storage medium to perform coarsening of the graph is also provided.

### CROSS REFERENCE TO RELATED APPLICATION

This application claims priority under USC§ 119 from Chinese Patent Application number 200710110101.4, filed on Jun. 15, 2007, the entire contents of which are incorporated herein by reference.

### BACKGROUND OF THE INVENTION

1. Field of the Invention

The present invention relates to graph coarsening, and more particularly to a system and method for coarsening a graph so as to discover a community rapidly and accurately.

2. Description of the Related Art

In the real world, many data such as social network (e.g., networks in the bank, financial service, insurance, and health care industries), life science network (e.g., protein interaction network), computer network (e.g. World Wide Web, the Internet) can be modeled as graphs. Furthermore, most of the graphs display community structure (i.e. group of vertices) within which connections are denser but between which are sparser. Therefore, it is useful to understand and analyze various networks by discovering these communities. In terms of social network, some networks are large and unknown, and it is beyond human capability to grasp the colony information thereof, for example, the personal telecommunications records maintained by the telecommunications carrier may constitute a telecommunications network. By way of community detection, we can predict the actual functional colony using the computers. Such colonies can be used to analyze the features of the colonies and the associations therebetween, and customize their particular policies regarding sales, advertising and marketing. The significance of data mining is to analyze and predict.

To better understand the relationship between the network and the community, an example regarding the computer network is given below. For a network containing a plurality of web pages, each web page can be regarded as a vertex, and the hyperlinks between the pages as edges. By partitioning the web pages in the network, the authority communities within the network can be found. Authority communities within the network refer to collections of web pages with identical or similar contents, which can be used to help users browse and search their desired information, so that the process can be efficient and convenient.

With the development of information technology, many researchers developed various solutions for discovering communities from the networks. The Modularity Q solution proposed in 2004 is considered important means for evaluating the community structural attribute. For details on Modularity Q solution, see M. E. J. Newman and M. Girvan, Finding and Evaluating Community Structure in Network, Physical Review E series, 2004. Meanwhile, Newman employs Modularity Q solution to evaluate the community quality discovered by various betweenness. However, these methods are time consuming and limited to process the graph under 10000 vertices. The heuristics algorithms in Modularity Q solution (such as greedy algorithms) perform partitioning with low quality, and thus can not always result in good partitioning for various graphs.

Thereafter, a few spectral based approaches were proposed (for example, see S. White and P. Smyth, A Spectral Clustering Approach to Finding communities in Graphs. Proceedings of the SIAM International Conference on Data Mining, Newport Beach, 2005, and M. E. J. Newman, Modularity and Community Structure in Networks, PNAS. 0601602103, 2006), to improve the quality of the detected communities. However, among the new approaches, large-scale matrix computations and lower-order approximations are extremely space- and time-consuming. Although they are more efficient than the Modularity Q solution, the bottleneck on large graphs still can not be solved.

### SUMMARY OF THE INVENTION

In light of the above, a scalable system and method is proposed, which coarsens a graph using the multilevel paradigm, wherein the coarsened graphs can be easily refined into high quality communities.

According to a first aspect of the invention, a method for coarsening a graph, the graph including a plurality of vertices each having a respective position in the graph, the method including the steps: selecting a vertex from the plurality of vertices; calculating a merge modularity gain between the selected vertex and its adjacent vertices, wherein the adjacent vertices are a function of the position of the selected vertex in the graph; calculating mathematically a similarity between the selected vertex and its adjacent vertices; determining mathematically, based on the calculated merge modularity gain and similarity, whether the selected vertex can be merged with one of its adjacent vertices; and performing the merge when merge is determined possible.

According to a second aspect of the invention, a system for coarsening a graph, the graph including a plurality of vertices, the system consisting: initial coarsening means, for the selected vertex, for calculating the merge modularity gain between the selected vertex and its adjacent vertices; bias adjusting means for calculating the similarity between the selected vertex and its adjacent vertices; wherein, based on the calculated merge modularity gain and similarity, determining whether the selected vertex can be merged with one of its adjacent vertices, and performing the merge when merge is determined possible.

In the present invention, by introducing modularity into the multilevel paradigm, the graph is first coarsened based on the modularity stage by stage, and then similarity is used to avoid the coarsening of the vertices on the edges of different communities. As a consequence of this, the graph can be fast and accurately coarsened by using modularity and similarity, and then the clusters of vertices can be refined during the uncoarsening process.

The invention further provides a storage medium tangibly embodying a program of machine-readable instructions executable by a digital processing apparatus to carry out a method for coarsening a graph, the graph including a plurality of vertices each having a respective position in the graph, the method consisting:

selecting a vertex from the plurality of vertices;

calculating a merge modularity gain between the selected vertex and its adjacent vertices, wherein the adjacent vertices are a function of the position of the selected vertex in the graph;

calculating mathematically similarity between the selected vertex and its adjacent vertices;

determining mathematically, based on the calculated merge modularity gain and similarity, whether the selected vertex can be merged with one of its adjacent vertices; and

performing the merge when merge is determined possible.

The present invention and its embodiments will be more fully understood by reference to the Drawings and the Detailed Description of the Preferred Embodiments that follow.

### BRIEF DESCRIPTION OF THE DRAWINGS

The foregoing and other objects, aspects, and advantages will be better understood from the following non-limiting detailed description of preferred embodiments of the invention with reference to the drawings that include the following:

FIG. 1A and FIG. 1B illustrate examples for network community detection using the invention.

FIG. 2 is a block diagram showing the concept of multilevel paradigm of the invention.

FIG. 3 is the block diagram of the system according to the invention.

FIG. 4 is a flowchart of the method according to the invention.

FIG. 5 is a flowchart of the method according to preferable embodiments of the invention.

FIG. 6A to FIG. 6F illustrate the steps of FIG. 5.

FIGS. 7A and 7B are respectively a graph and a histogram of performance evaluation comparison between the invention and prior art solutions.

FIG. 8 is a graph for comparing the modularity between the invention and prior art solutions.

### DETAILED DESCRIPTION OF THE PREFERRED EMBODIMENTS

Referring now to the drawing, an example for network community detection (i.e., graph coarsening) using the invention is described.

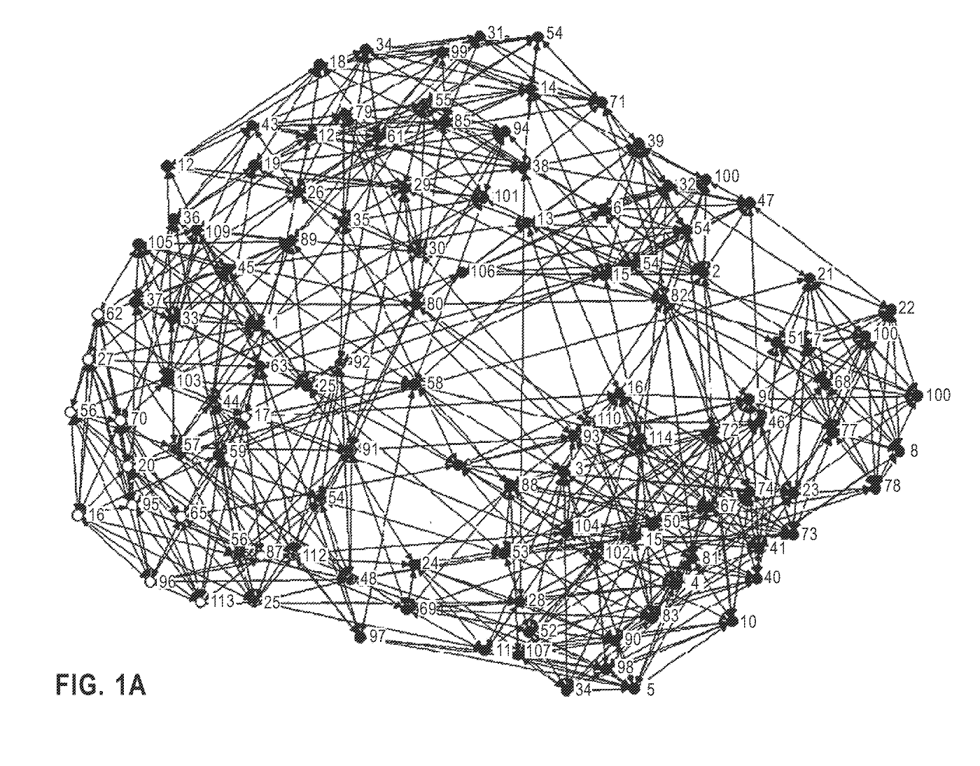

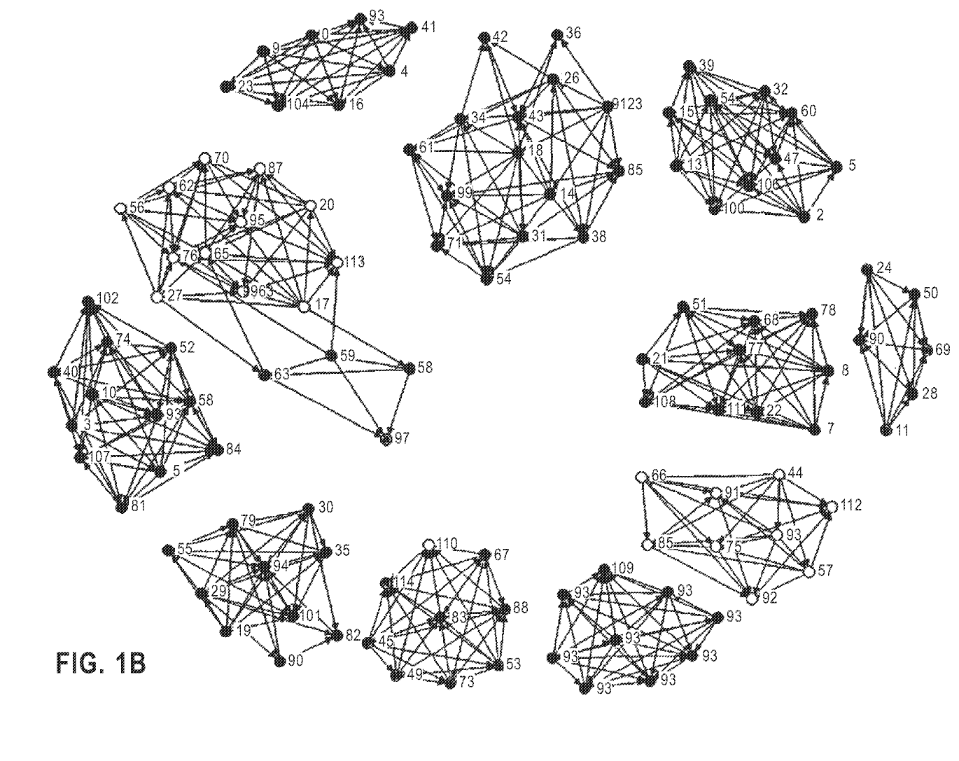

FIGS. 1A and 1B illustrate the case of a social network. FIG. 1A shows a schedule of Division IA colleges American football games for the regular season Fall 2000, wherein each vertex in the graph represents a team, and the edges (i.e., connections) between two teams indicative of games between the two teams they connected. FIG. 1B shows the result of discovering the communities in the network and then partitioning the network into communities by using the invention. As can be seen from the partition result, games are more frequent between members of the same conference than between those of different conferences. As far as this example is concerned, the significance of community detection lies in that the partitioning of the teams can be predicted by way of the game schedule.

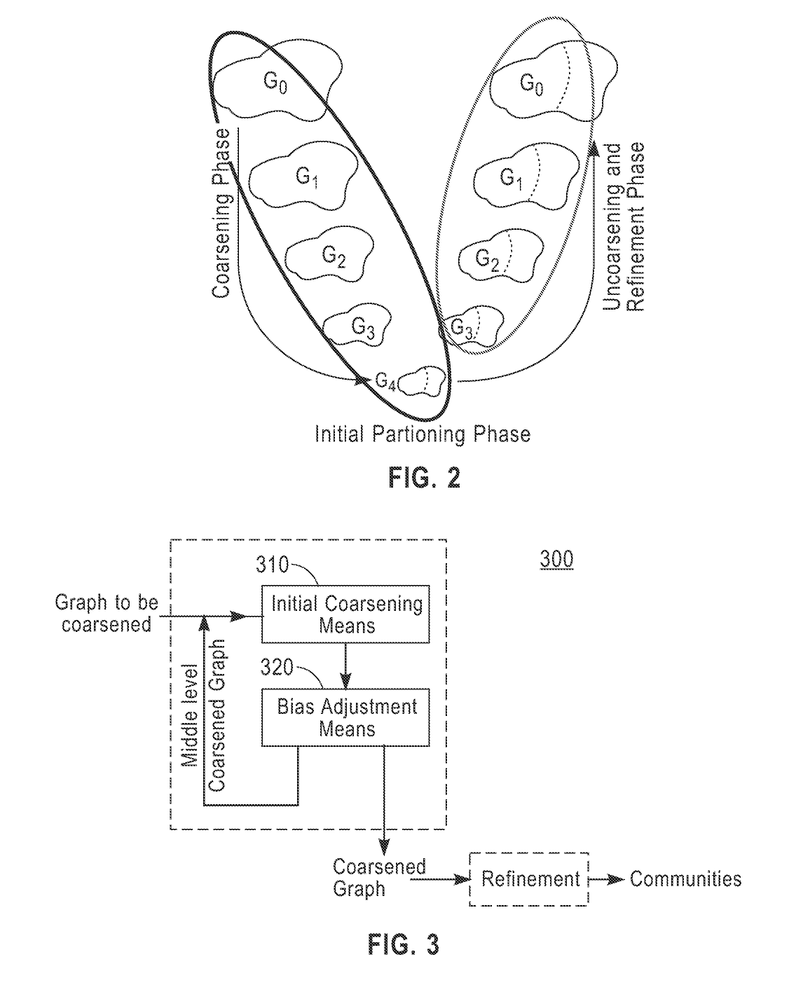

For the network of FIG. 1A, the invention coarsens the graph fast and accurately using the modularity and similarity of the network (i.e., the graph) by way of the multilevel paradigm, so as to obtain the coarsening result of FIG. 1B. Then, the graph in FIG. 1B can be refined into high quality community. FIG. 2 illustrates the concept of multilevel paradigm.

The left side ellipse of FIG. 2 shows the process of graph coarsening. In FIG. 2, G0 represents the original graph, G1-G4 represent the middle levels of graphs obtained during the coarsening. During the coarsening, the graph is coarsened level by level so as to reduce the number of vertices in the graph, until it is not possible to increase modularity gain by combining any vertices or clusters any more (e.g., as shown in FIG. 2, reaching the graph of G4). It is appreciated, although 5 levels of paradigms are shown in FIG. 2, any numbers of levels of paradigms can be used as desired.

The right side ellipse of FIG. 2 shows the refining process by using the levels of middle graphs obtained during the coarsening process. During the course of refinement, numerous classical refinement methods can improve the initial partition, for example see B. W. Kernighan and S. Lin, An efficient heuristic procedure for partitioning graphs. Bell Sys. Tech. J., 49(2):291-308, 1970, and C. M. Fiduccia and R. M. Mattheyses, A linear-time heuristic for improving network partitions. In 25 years of DAC:Papers on Twenty-five years of electronic design automation, pages 241-247, New York, N.Y., USA, 1988. ACM Press. Since the refinement process is of no concern to the invention, details thereof are omitted.

Below, system 300 for graph coarsening according to the invention is described with reference to FIG. 3. As shown in FIG. 3, system 300 comprises initial coarsening means 310 and bias adjusting means 320. When a graph to be coarsened (i.e., the current graph) is input into system 300, a random order can be assigned to each vertex in the graph so as to visit the vertices in the graph in random order. The initial coarsening means 310, when visiting a vertex (i.e., the selected vertex), calculates the merge modularity gain between the selected vertex and its adjacent vertices (i.e., vertices having edges with the selected vertex). Adjacent vertices are determined using respective position of vertices using the concepts of some appropriate distance metric for graphical and spatial distribution of vertices with respect to a common reference point. The bias adjusting means 320 calculates the similarity between the selected vertex and its adjacent vertices. The system 300 determines whether the selected vertex can be merged with one of its adjacent vertices based on the mathematically calculated merge modularity gain and similarity, and performs the merge when merge is determined possible, so as to coarsen the graph.

System 300 being a recursive system resides in the following aspects. On one hand, for a current graph (e.g., the original graph G0 in FIG. 2), the system 300 will visit each vertex in the graph in random order, and repeat the process for each vertex. Having visited all vertices in the current graph, the coarsened middle level graph of the current level is obtained (e.g., the middle graph G1 in FIG. 2). On the other hand, each time a coarsened middle level graph is obtained (e.g., the middle graphs G1, G2 and G3 in FIG. 2), the system 300 will further coarsen the coarsened middle level graph, until it is no longer possible to increase the modularity gain of the graph (e.g., reaching the middle graph G4 of FIG. 2). By using system 300 to coarsen the graph, the graph can be refined into its original graph fast and with high quality.

The term “vertex” is used herein. In is noted that in the original graph, one “vertex” includes only itself, however, in the coarsened middle level graph, one “vertex” may include one or more vertices in the original graph, meanwhile the edges in the coarsened graph may also constitute of a plurality of edges in the original graph, as a result, the vertex in the coarsened graph may also be referred to as a “cluster”.

According to a preferred embodiment of the invention, the merge modularity gain and similarity of the graph or the subgraph are calculated by using Modularity Q formula. Modularity Q formula is a function for calculating the community intensity of the network, which is an index for measuring community intensity (that is, whether the community is good or bad). However, it is appreciated that the implementation of the invention does not rely on the use of Modularity Q formula, any algorithm that can calculate the community intensity and then obtain the merge modularity gain and similarity of the vertices in the network can be applied in the invention.

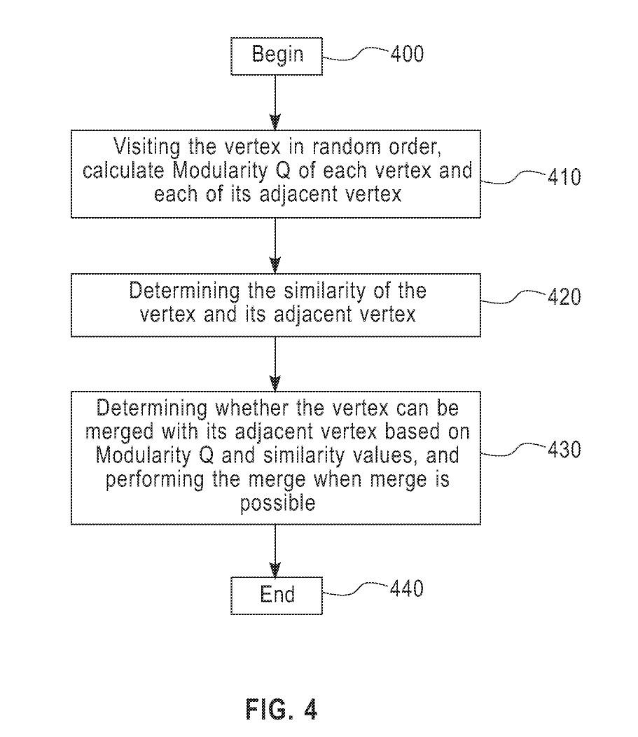

FIG. 4 is a flowchart of the method of the invention. The method of FIG. 4 starts from step 400, and then enters step 410, wherein the merge modularity gain of the selected vertex and its adjacent vertices are calculated. Then, in step 420, the similarity of the selected vertex and its adjacent vertices are calculated. Next, in step 430, based on the calculated merge modularity gain and similarity, determining whether the selected vertex can be merged with one of its adjacent vertices, and performing the merge when merge is determined possible, so as to achieve graph coarsening. The method of the invention ends in step 440.

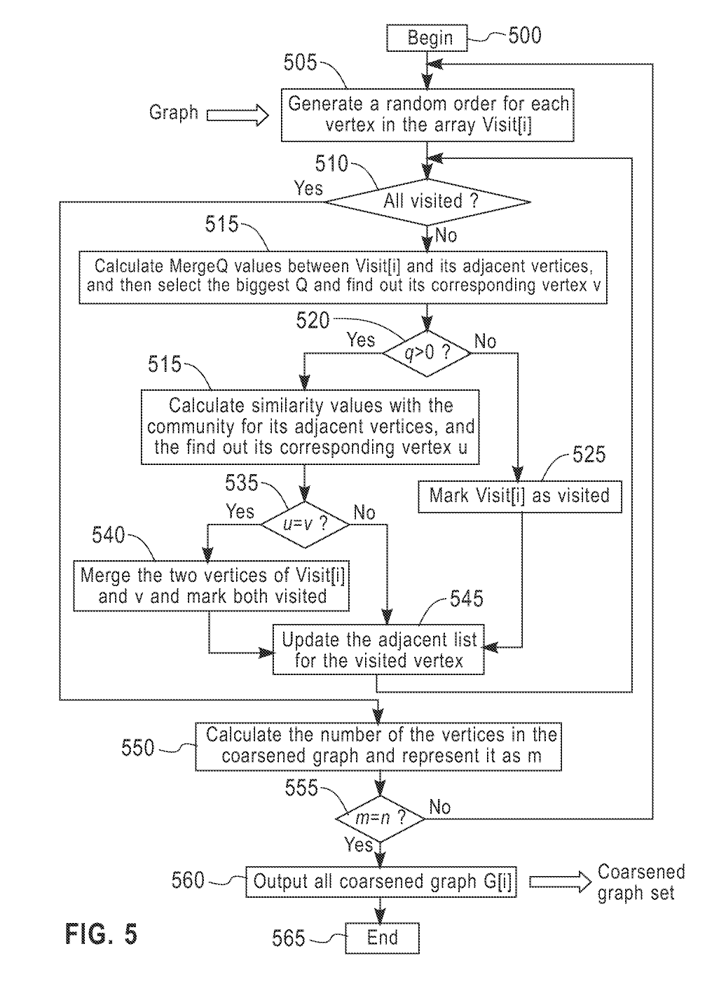

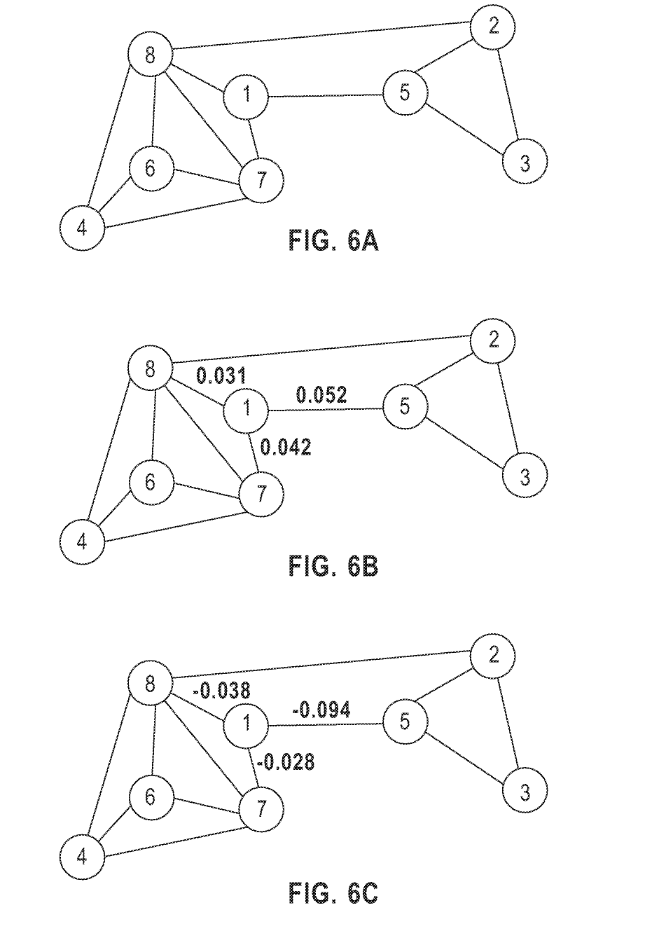

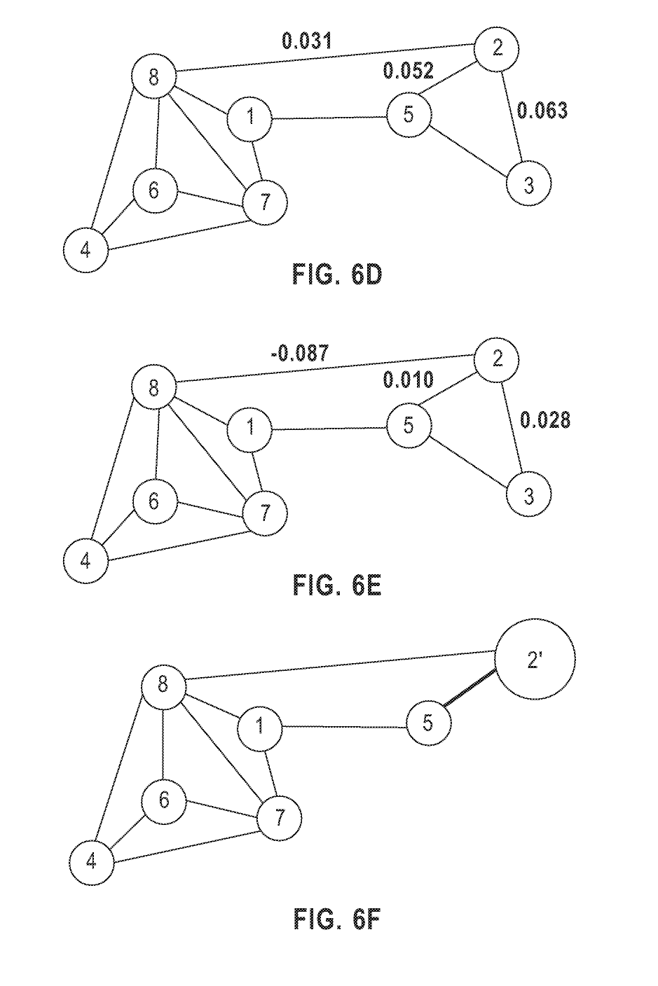

The preferred embodiments of the invention will be described in connection with reference to FIG. 5 and FIGS. 6A-6F, wherein FIG. 5 shows the preferred embodiments of the invention, while FIGS. 6A-6F illustrates the steps in FIG. 5.

The method of FIG. 5 starts in step 500, and then enters step 505, wherein a random order visit[i] (i=1, . . . , n, n indicative of the total number of vertices in the current graph) is generated for each vertex in the graph. FIG. 6A corresponds visually to step 505 of FIG. 5, wherein a graph of 8 vertices is shown (assuming the graph in FIG. 6A is the original graph). In this graph, a random order of 1-8 is assigned, respectively, to each vertex. It shall be appreciated that FIG. 6 shows a graph with 8 vertices only for ease of illustration, the graph can have any number of vertices as required in practice.

The method of FIG. 5 then proceeds to step 510, to determine if all the vertices in the graph have been visited. If it is determined “YES” in step 510, then the method goes to step 550, as described later. If it is determined “NO” in step 510, then the method goes to step 515, wherein the merge modularity gain of the vertex with random order of visit[i] and its adjacent vertices are calculated, and then the vertex v with the biggest merge modularity gain is selected. This step is illustrated in FIG. 6B, wherein it is assumed that the vertex of random order 1 (i.e., vertex 1) is first visited, as a result, the merge modularity gain of vertex 1 and its adjacent vertices 5, 7 and 8 are calculated.

According to a preferred embodiment of the invention, the merge modularity gain is calculated based on Modularity Q formula. Modularity Q formula is a basic function for calculating the modularity within a graph or subgraph, as shown in formula (1) below.

$$\begin{matrix}Q = \frac{1}{2 \vert E \vert} {\sum }_{i ∈ V , j ∈ V} ( {A}_{ij} - \frac{d ( i ) d ( j )}{2 \vert E \vert} ) δ ( C ( i ) , C ( j ) ) \\ = \frac{1}{2 \vert E \vert} {\sum }_{i ∈ V , j ∈ V} {A}_{ij} δ ( C ( i ) , C ( j ) ) - \frac{1}{2 \vert E \vert} {\sum }_{i ∈ V , j ∈ V} \frac{d ( i ) d ( j )}{2 \vert E \vert} δ ( C ( i ) , C ( j ) ) \\ = \frac{1}{2 \vert E \vert} {\sum }_{C = 1}^{k} {E}_{c} - \frac{1}{4 {\vert E \vert}^{2}} {\sum }_{i , j} d ( i ) d ( j ) δ ( C ( i ) , C ( j ) ) \\ = \frac{1}{2 \vert E \vert} {\sum }_{C = 1}^{k} {E}_{c} - \frac{1}{4 {\vert E \vert}^{2}} {\sum }_{i} ( d ( i ) {\sum }_{j} d ( j ) ) δ ( C ( i ) , C ( j ) ) \\ = \frac{1}{2 \vert E \vert} {\sum }_{C = 1}^{k} {E}_{c} - \frac{1}{4 {\vert E \vert}^{2}} {\sum }_{C = 1}^{k} {D}_{c}^{2} \\ = {\sum }_{C = 1}^{k} \frac{{E}_{c}}{2 \vert E \vert} - {( \frac{{D}_{c}}{2 \vert E \vert} )}^{2}\end{matrix} \qquad ( 1 )$$

wherein,
Q: modularity of the vertex visit[i] and its adjacent vertices;
Aij: the adjacent matrix to which the graph corresponds;
C(i): the partition in which vertex i is located;
d(i): the degree of vertex i (i.e., the number of edges connected to vertex i);
Dc: the sum of the degrees of all vertices in the partition c;
Ec: the number of edges in partition c; and

$$δ = \{ {\begin{matrix}0 & C ( i ) \neq C ( j ) \\ 1 & C ( i ) = C ( j )\end{matrix}}_{:}$$

1 when vertices i and j belong to the same partition; otherwise 0.

Based on the above Modularity Q formula, the modularity gain generated during the vertex combining process. According to a preferred embodiment of the invention, this is calculated by using formula (2) below.

$$\begin{matrix}\begin{matrix}\begin{matrix}{Q}_{A} = \frac{{E}_{A}}{2 \vert E \vert} - {( \frac{{D}_{A}}{2 \vert E \vert} )}^{2} \\ {Q}_{B} = \frac{{E}_{B}}{2 \vert E \vert} - {( \frac{{D}_{B}}{2 \vert E \vert} )}^{2}\end{matrix} \\ {Q}_{C} = \frac{{E}_{C}}{2 \vert E \vert} - {( \frac{{D}_{C}}{2 \vert E \vert} )}^{2} = \frac{( {E}_{A} + {E}_{B} + 2 {E}_{AB} )}{2 \vert E \vert} - {( \frac{{D}_{A} + {D}_{B}}{2 \vert E \vert} )}^{2}\end{matrix} \\ Δ {Q}_{C} = {Q}_{C} - {Q}_{A} - {Q}_{B} = \frac{1}{\vert E \vert} ( {E}_{AB} - \frac{{D}_{A} {D}_{B}}{2 \vert E \vert} )\end{matrix} \qquad ( 2 )$$

wherein,
Q_{A}: Q of vertex visit[i] (vertex 1 in the example);
Q_{B}: Q of the adjacent vertex (vertices 5, 7, and 8 in the example);
Q_{C}: Q of the vertex obtained by merging vertex visit[i] and its adjacent vertex;
ΔQ_{C}: merge modularity gain of vertex visit[i] and its adjacent vertices.

For example, for vertex 1, when using ΔQ_{C}=Q_{c}−Qₐ−Q_{b} to calculate its modularity gain with vertex 5, C represents the graph constituting of vertices 1 and 5, A represents the graph constituting of vertex 1, and B represents the graph constituting of vertex 5. The calculated ΔQ_{C} is indicative of the merge modularity gain of vertices 1 and 5. The same process can be used to calculate the merge modularity gain of vertex 1 with vertex 7 and with vertex 8.

As shown in FIG. 6B, the merge modularity gain of vertex 1 with vertex 5 is 0.052, that with vertex 7 is 0.038, and that with vertex 8 is 0.031, wherein the vertex with the biggest merge modularity gain is vertex 5.

Then the method proceeds to step 520, to determine if the biggest merge modularity gain of vertex 1 is greater than 0. If “YES”, the method proceeds to step 530, otherwise to step 525, so as to mark the vertex as visited.

As shown in FIG. 6B, all the merge modularity gains of vertex 1 are greater than 0, therefore the method goes into step 530, to calculate the similarity of vertex 1 with its adjacent vertices 5, 7 and 8, so as to find the vertex u with the biggest similarity.

According to a preferred embodiment of the invention, the similarity is also calculated by using above formula (2), wherein only Q_{A}, Q_{B}, Q_{C} and ΔQ_{C} are assigned different meaning than calculating the modularity gain.

To take the selected vertex 1 as an example, its adjacent vertices are vertices 5, 7 and 8, and ΔQ_{C}=Q_{C}−Q_{A}−Q_{B} is used to calculate the similarity of vertex 5 and other adjacent vertices of vertex 1, C represents the graph constituting of vertices 1, 5, 7 and 8, A represents the graph constituting of vertices 1, 7 and 8, and B represents the graph constituting of vertex 5. Then, the calculated ΔQ_{C} is indicative of the similarity of vertices 1 and 5. Likewise, the similarity of vertex 1 with vertex 7 and vertex 8 can be calculated.

FIG. 6C illustrates the calculated similarity of vertex 1 with its adjacent vertices 5, 7 and 8, with similarity being −0.095, −0.028, and −0.038, respectively, and vertex 7 is the one with the biggest similarity.

Then, it is determined if vertex u is the same vertex as vertex v, that is, if the vertex with the biggest merge modularity gain and the vertex with the biggest similarity are the same vertex.

If “YES”, the method goes to step 540, to merge vertices u and v, and mark them as visited, then the method enters step 545. However, as shown in FIGS. 6B and 6C, for the selected vertex 1, the vertex with the biggest merge modularity gain and the vertex with the biggest similarity are not the same vertex, meaning the determination in step 535 is “NO”, then the method goes directly to step 545. In step 545, the adjacent list of the visited vertices are updated (e.g., adjusting the random order of vertex 1, so that its random order is later than all other vertices in the graph), and then returns to step 510 to determine if there are unvisited vertices in the graph.

With step 510, then vertex with random order 2 (that is, vertex 2) is visited. Steps 515 to 535 are repeated for vertex 2. The merge modularity gain calculated for vertex 2 with its adjacent vertices 3, 5 and 8 in step 515 are 0.063, 0.052, 0.031, respectively, wherein vertex 3 has the biggest merge modularity gain (as shown in FIG. 6D). The similarity calculated for vertex 2 with its adjacent vertices 3, 5 and 8 in step 530 are 0.028, 0.010 and −0.087, respectively, wherein vertex 3 has the biggest similarity (as shown in FIG. 6E). As a consequence of this, the determination in step 535 for vertex 2 is “YES”. Then, the method of FIG. 5 enters step 540, wherein vertices 2 and 3 are combined, and these vertices are marked as visited. As shown in FIG. 6E, vertices 2 and 3 are combined as a new vertex 2′. Next, the method forwards to step 545, to update the adjacent list of the visited vertex by modifying its adjacent information in the corresponding adjacent list. It shall be appreciated that updating the adjacent list of a visited vertex is known in the art, and the details thereof will be omitted.

Then, the method of the invention returns again into step 510, to determine if all vertices in the graph have been visited. If “NO” in step 510, repeat the above process for the next vertex. Recursively performing the above process, until all vertices in the graph have been visited (i.e., the determination in step 510 is “YES”).

After having visited all vertices, the method of FIG. 5 goes into step 550, to calculate the number m of vertices in the current middle graph obtained by this round of coarsening. Then, in step 555, the number m is compared with the number n of vertices in the last round of coarsening process (that is, the number of vertices at the beginning of this round or coarsening process), to determine if they are equal to each other. When the determination of step 555 is “YES”, i.e., the numbers (n and m) of vertices in the successive two rounds of coarsening are the same, which is indicative of the fact that no more coarsening is possible, the method goes to step 560 to output all middle level graphs G[i] (i.e., a coarsened graph set, e.g., G1-G4 in FIG. 2) obtained during the coarsening.

If the determination of step 555 is “NO” (that is, the graph can be further coarsened), the method returns to step 510, the current coarsened graph is recursively input to initial coarsening means 310, to randomly order the vertices in the coarsened graph, and repeat the above initial coarsening and bias adjusting processes.

For the example of FIG. 6, since it is coarsening the original graph, the obtained coarsened graph is the first level middle graph, therefore, the number m of vertices in the first level middle graph is compared with the number n (n=8) of vertices in the original graph. In FIG. 6, m is certainly smaller than 8 (since at least vertices 2 and 3 are already combined as new vertex 2′), therefore, the first level middle graph can be further coarsened (that is, it will be input to the initial coarsening means 310, and undergo the next round of coarsening).

Then, the method of the invention ends in step 565.

In the invention, the graph is coarsened based on the modularity and similarity of the vertices. In the proposed method, first, the adjacent vertex around the randomly chosen vertex, having the biggest merge modularity gain, is identified (i.e., visiting each vertex in the graph by using random order, and combining the selected vertex with the adjacent vertex or cluster with the locally maximum merge modularity gain). Then, the random order is adjusted to use the similarity to merge the vertices (i.e., to adjust the order of those vertices that might locate on the edge of the community via similarity). The method can avoid low community quality attributing to the random order visit. By recursive coarsening, a coarsened graph set is output, when it is no longer possible to add the modularity gain by merging any cluster or vertex. Such coarsened graph can then be refined as high quality community.

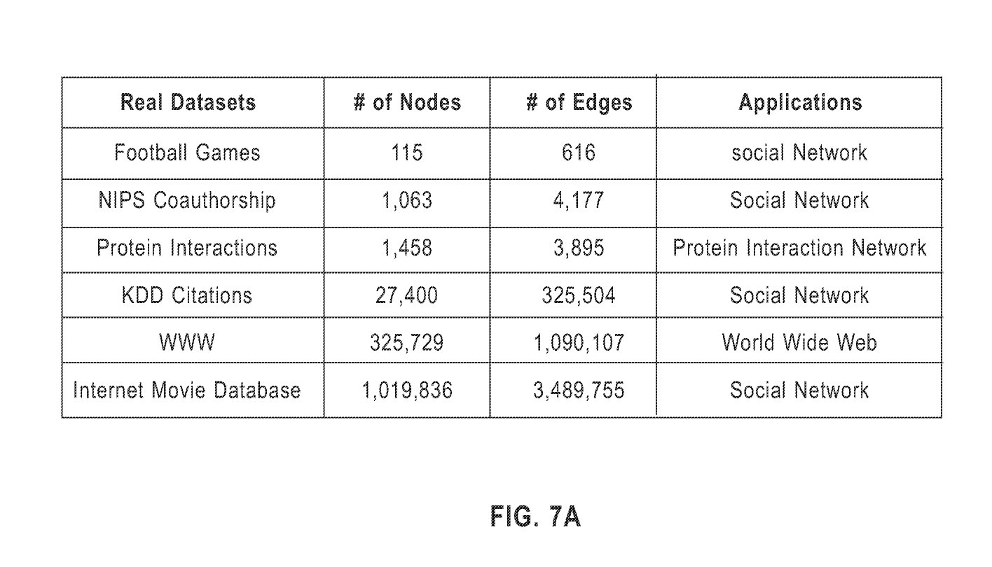

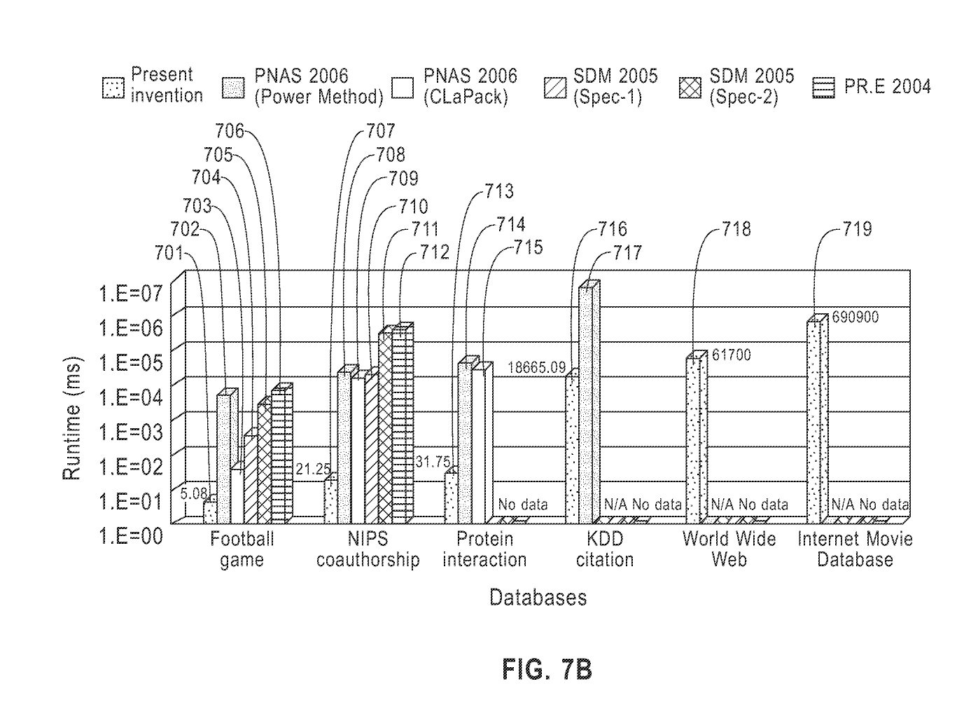

As compared with existing community detection algorithms, the present invention can process network with higher number of vertices and edges, and discover the community within the network fast and accurately. FIG. 7A shows the names of the actual databases employed by the invention, the number of vertices and edges of each database and the application field each database belongs to. FIG. 7B is a histogram of performance evaluation comparison between the system and method of the invention and prior art solutions. Legend shows keys to various algorithms in the comparison. FIG. 7B is the histogram, wherein the horizontal axis shows the various employed databases, and the vertical axis the log run time of the various algorithms.

Bar lines 701, 707, 713, 716, 718 and 719 correspond to the runtime bar values using present invention. Bar lines 702, 708, 714 and 717 correspond to the runtime bar values using PNAS 2006 (Power Method). Bar lines 703, 709, and 715 correspond to the runtime bar values using PNAS 2006 (CLaPack). Bar lines 704 and 710 correspond to the runtime bar values using SDM 2005 (Spec-1). Bar lines 705 and 711 correspond to the runtime bar values using SDM 2005 (Spec-2). Bar lines 706 and 712 correspond to runtime bar values using PR.E. 2004.

It should be noted, in FIG. 7B, for SDM 2005 (Spec-1) algorithm, SDM 2005 (Spec-2) algorithm and PR. E 2004 algorithm, since the invention does not obtain the program data of the protein interaction, KDD citation, WWW and Internet Movie databases, the run time in these databases are not calculated, which is shown as “No data” in FIG. 7B. In addition, PNAS 2006 (Power Method) algorithm and PNAS 2006 (ClaPack) algorithm are not capable of handling databases on the order of KDD citation, WWW and Internet Movie databases, which is shown as “N/A” in FIG. 7B.

As can be seen from FIG. 7A, the present invention can handle network containing a larger number of vertices rapidly, as compared with the existing algorithms.

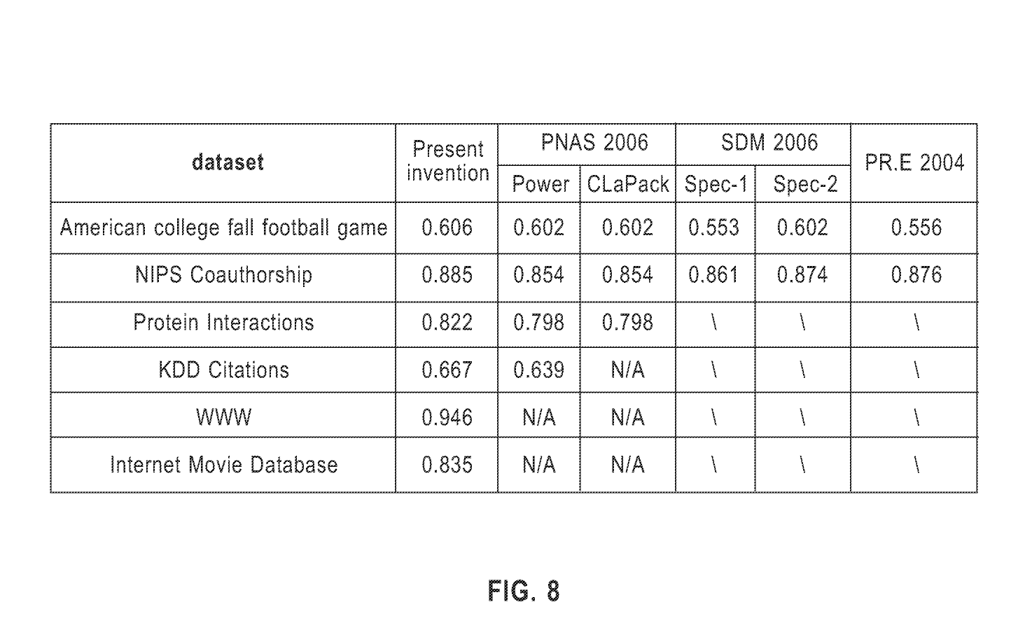

FIG. 8 is the graph for comparing the modularity between the system and method of the invention and prior art solutions. As can be seen from FIG. 8, the modularity of the solution of the invention is higher than the existing algorithms, in other words, the community detection of the invention is advantageous in accuracy over existing algorithms.

Those skilled in the art would appreciate that, the embodiment of the invention can be provided in the form of a method, system or computer program product. Therefore, the invention may adopt the form of an all-hardware embodiment, all-software embodiment or combined software and hardware embodiment such as, but not limited to, commercially available general purpose computer or a laptop. A typical combination of hardware and software comprises a universal computer system with a computer program which is loaded and executed to control the computer system to execute the above method.

The present invention may be embedded in the computer program product that incorporates all the features enabling the method described herein to implement. The computer program product is contained in one or more computer readable storage medium (including but not limited to a disk memory, CD-ROM, optical memory etc.) that has computer readable program codes stored therein.

The present invention has been described with reference to the flowchart and/or block diagram of the method, system and computer program product according to the invention. Each block in the flowchart and/or block diagram and a combination of the blocks in the flowchart and/or block diagram obviously can be achieved by computer program instructions. These computer program instructions may be provided to a universal computer, dedicated computer, embedded type processor or processors of other programmable data processing equipments, to generate a machine to thereby instruct (through the computer or processors of other programmable data processing equipments) to generate means for achieving functions specified in one or more blocks in the flowchart and/or block diagram.

These computer program instructions may be stored in a read memory of one or more computer that can instruct the computer or other programmable data processing equipments to exert themselves in a particular way, such that the instructions stored in the computer readable memory generate a manufactured product that comprises means for achieving the instructions of the functions specified in one or more blocks in the flowchart and/or block diagram. A storage medium tangibly embodying a program of machine-readable instructions executable by a digital processing apparatus is also one of the many possible means to carry out a method for coarsening a graph.

These computer program instructions may be loaded into one or more computer or other programmable data processing equipments, such that a series of operation steps are executed in the computer or other programmable data processing equipments, to thereby generate a computer-implemented process in each such equipment, so that the instructions executed in the equipment provide for the steps specified in one or more blocks in the flowchart and/or block diagram.

The above has described the principle of the invention in conjunction with the preferred embodiments of the invention, which, however, is illustrative and cannot be construed as limiting the invention. Various changes and variations may be made to the invention by those skilled in the art without departing from the spirit and scope of the invention as defined in accompanying claims.

What is claimed is:

1. A method for coarsening a graph, said graph including a plurality of vertices each having a respective position in said graph, the method comprising:
selecting a vertex from said plurality of vertices;
calculating a merge modularity gain between said selected vertex and its adjacent vertices, wherein said adjacent vertices are a function of the position of said selected vertex in said graph;
calculating mathematically a similarity between said selected vertex and its said adjacent vertices;
determining mathematically, based on the calculated merge modularity gain and similarity, whether said selected vertex can be merged with one of its said adjacent vertices; and
performing the merge when merge is determined possible.

2. A method according to claim 1, further comprising:
updating the list of said adjacent vertices.

3. A method according to claim 1, further comprising:
repeating the steps of claim 1 for another selected vertex in said graph.

4. A method according to claim 1, wherein said selecting further includes:
assigning a random order for each vertex and each time a coarsened graph is obtained, following said random order for each vertex in said coarsened graph.

5. A method according to claim 4, further comprising:
comparing the number of vertices in the current level of coarsened graph and the number of vertices in the previous level of coarsened graph; and
repeating the following steps, if the number of vertices in the said current level of coarsened graph is less than the number of vertices in said previous level of coarsened graph, said steps comprising:
selecting a vertex from plurality of vertices;
calculating a merge modularity gain between said selected vertex and its said adjacent vertices, wherein said adjacent vertices are a function of the position of said selected vertex in said graph;
calculating mathematically similarity between said selected vertex and its said adjacent vertices;
determining mathematically, based on the calculated merge modularity gain and similarity, whether said selected vertex can be merged with one of its said adjacent vertices; and
performing the merge when merge is determined possible.

6. A method according to claim 4, further comprising:
comparing the number of vertices in said current level of said coarsened graph and the number of vertices in said previous level of coarsened graph; and
outputting the levels of said coarsened graph, if the number of vertices in said current level of coarsened graph is equal to the number of vertices in said previous level of coarsened graph.

7. A method according to claim 1, wherein said merge modularity gain and said similarity are calculated based on the Modularity Q formula.

8. A method according to claim 1, wherein said calculating said merge modularity gain, ΔQ_{C} of said selected vertex and one of its said adjacent vertices includes:
calculating a modularity Q_{C} of the graph constituting said selected vertex and one of its said adjacent vertices, Q_{A} of the graph constituting said selected vertex, and Q_{B} of the graph constituting one of its said adjacent vertices, and by calculating ΔQ_{C}=Q_{C}−Q_{A}−Q_{B}.

9. A method according to claim 7, further comprising:
determining an adjacent vertex with the biggest merge modularity gain, after calculating said merge modularity gain of each said adjacent vertex of said selected vertex.

10. A method according to claim 1, further comprising:
determining if said selected vertex can be merged with any of its said adjacent vertices by obtaining the vertex with the biggest merge modularity gain and the vertex with the biggest similarity.

11. A method according to claim 10, further comprising:
determining if the vertex with the biggest merge modularity gain and the vertex with the biggest similarity are the same vertex;
determining that said selected vertex can be merged with the vertex with both the biggest merge modularity gain and the biggest similarity; and
changing the random order of said selected vertex if the vertex with the biggest merge modularity gain and the vertex with the biggest similarity are different adjacent vertices.

12. A method according to claim 11 further comprising:
calculating said similarity only when all the merge modularity gains are greater than 0.

13. A system for coarsening a graph, said graph including a plurality of vertices each having a respective position in the said graph, comprising:
means for selecting a vertex from said plurality of vertices;
means for calculating a merge modularity gain between said selected vertex and its adjacent vertices, wherein said adjacent vertices are a function of the position of said selected vertex in said graph;
means for calculating mathematically a similarity between said selected vertex and its said adjacent vertices;
means for determining mathematically, based on the calculated merge modularity gain and similarity, whether said selected vertex can be merged with one of its said adjacent vertices; and
means for performing the merge when merge is determined possible.

14. A system according to claim 13, further includes:
means for updating the list of said adjacent vertices.

15. A system according to claim 13, further includes:
means for assigning a random order for each said vertex in said graph.

16. A system according to claim 13, further includes:
means for comparing the number of vertices in the current level of coarsened graph and the number of vertices in the previous level of coarsened graph; and
means for repeating the following steps, if the number of vertices in the said current level of coarsened graph is lesser than the number of vertices in said previous level of coarsened graph, said steps comprising:
selecting a vertex from plurality of vertices;
calculating a merge modularity gain between said selected vertex and its said adjacent vertices, wherein said adjacent vertices are a function of the position of said selected vertex in said graph;
calculating mathematically similarity between said selected vertex and its said adjacent vertices;
determining mathematically, based on the calculated merge modularity gain and similarity, whether said selected vertex can be merged with one of its said adjacent vertices; and
performing the merge when merge is determined possible.

17. A system according to claim 13, further includes:
means for comparing the number of vertices in said current level of said coarsened graph and the number of vertices in said previous level of coarsened graph; and
means for outputting the levels of said coarsened graph, if the number of vertices in said current level of coarsened graph is equal to the number of vertices in said previous level of coarsened graph.

18. A system according to claim 13, wherein said merge modularity gain and said similarity are calculated based on a Modularity Q formula.

19. A system according to claim 13, wherein said initial coarsening means further includes:
means for calculating merge modularity gain, ΔQ_{C} of said selected vertex and one of its said adjacent vertices by calculating a modularity Q_{C} of the graph constituting said selected vertex and one of its said adjacent vertices, Q_{A} of the graph constituting said selected vertex, and Q_{B} of the graph constituting one of its said adjacent vertices, and by calculating ΔQ_{C}=Q_{C}−Q_{A}−Q_{B}.

20. A system according to claim 13, further includes:
means for determining an adjacent vertex with the biggest merge modularity gain, after calculating said merge modularity gain of each said adjacent vertex of said selected vertex.

21. A system according to claim 19, further includes:
means for determining if said selected vertex can be merged with any of its said adjacent vertices by obtaining the vertex with the biggest merge modularity gain and the vertex with the biggest similarity.

22. A system according to claim 21, further comprising:
means for determining if the vertex with the biggest merge modularity gain and the vertex with the biggest similarity are the same adjacent vertex;
means for determining that said selected vertex can be merged with the vertex with both the biggest merge modularity gain and the biggest similarity; and
means for changing the random order of said selected vertex if the vertex with the biggest merge modularity gain and the vertex with the biggest similarity are different adjacent vertices.

23. A storage medium tangibly embodying a program of machine-readable instructions executable by a digital processing apparatus to carry out a method for coarsening a graph, said graph including a plurality of vertices each having a respective position in said graph, the method comprising:
selecting a vertex from said plurality of vertices;
calculating a merge modularity gain between said selected vertex and its adjacent vertices, wherein said adjacent vertices are a function of the position of said selected vertex in said graph;
calculating mathematically similarity between said selected vertex and its said adjacent vertices;
determining mathematically, based on the calculated merge modularity gain and similarity, whether said selected vertex can be merged with one of its said adjacent vertices; and
performing the merge when merge is determined possible.

24. A storage medium of claim 23 to carry out said method for
coarsening said graph, said method further comprising:
updating the list of said adjacent vertices.
